(19) United States
(12) Patent Application Publication
(10) Pub. No.: US 2015/0354277 A1
(43) Pub. Date: Dec. 10, 2015

(54) AIRCRAFT MAINTENANCE PLATFORM FOR AIRCRAFT TIRE SERVICING

(71) Applicants: Clifford R. Hokanson, Kaysville, UT (US); Bill V. Anderson, Centerville, UT (US); Chase B. Parmer, Layton, UT (US)

(72) Inventors: Clifford R. Hokanson, Kaysville, UT (US); Bill V. Anderson, Centerville, UT (US); Chase B. Parmer, Layton, UT (US)

(21) Appl. No.: 13/862,815

(22) Filed: Apr. 15, 2013

(51) Int. Cl. E06C 1/39; B64F 5/00

(52) U.S. Cl. CPC E06C 1/39; B64F 5/00

(57) ABSTRACT

An apparatus and method are disclosed for enabling work on at least one aircraft or vehicle component, such as a tire. A work surface provides a platform for operators to service tires, including aircraft tires. The work surface includes depressions and guardrails to guide and secure the tires in a desired location along the work surface. A load portion, such as a ramp, facilitates loading/unloading of the tires onto the work surface. At least one column portion supports the work surface, and raises and lowers. A motor powers a screw jack which actuates the column portion. A cable support carries wires and cables to and from the apparatus. A buffer strip goes around the bottom of the beam, and acts to detect proximity to the mount surface. A tool tray and keyhole slots hold tools around the work surface. Power outlets on the work surface provide power.

### BACKGROUND

1. Field of the Invention

This invention relates to workbenches and aircraft maintenance, and more particularly relates to a workbench with features designed to assist with operator maintenance and repair of aircraft landing gear and tires.

2. Description of the Related Art

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a tire is a annular or ring-shaped covering fitted around wheel rim to protect the rim and support the weight of an aircraft or vehicle suspended above the wheel.

Typically, the fundamental materials of modern pneumatic tires are synthetic rubber, natural rubber, fabric and wire, along with carbon black and other chemical compounds. They consist of a tread and a body. The tread provides traction while the body provides containment for a quantity of compressed air.

Maintaining, inspecting, changing and repairing tires and wheels on aircraft can be very cumbersome to aircraft mechanics, in part, because of the difficulty of positioning heavy and cumbersome tires and wheels for efficacious servicing by operators. This maintenance and servicing is required at periodic intervals by regulatory authorities.

Typically, aircraft mechanics servicing aircraft tires make use of a tire changer that abuts one tire at a time on ground level, or simply hold the tire in position themselves, rather than at a convenient height for operators. The process of positioning and servicing only one tire at a time is cumbersome and inefficient. Mechanics have no implements available to them in the art for efficacious servicing of multiple tires and/or wheels simultaneously. Additionally, tools for servicing and storing aircraft tires are often not in proximity to the tire changer or bench, imposing additional difficulty upon aircraft mechanics.

In view of the foregoing, it is clear that these traditional maintenance platforms are not ideal and leave room for more optimal approaches.

### SUMMARY

From the foregoing discussion, it should be apparent that a need exists for an improved aircraft maintenance platform for safely and efficiently facilitating aircraft tire service, as well as a method. Beneficially, such an apparatus and method would provide a plurality of features and components to facilitate service of landing gear and tires.

The present invention has been developed in response to the present state of the art, and in particular, in response to the problems and needs in the art that have not yet been fully solved by currently available apparatuses and methods. Accordingly, the present invention has been developed to provide an apparatus and method for enabling work on at least one aircraft or vehicle component that overcome many or all of the above-discussed shortcomings in the art.

The apparatus for enabling work on at least one vehicle component includes a plurality of modules configured to functionally execute the necessary steps of positioning and working on at least one vehicle component from a workbench while in proximity to tools and power outlets and parts, baskets, accessories or subcomponents. The apparatus may be utilized by mechanics, machinists, pipefitters, electricians, inspectors, labors, parts installers, textile workers, hand loaders, and piece workers. The apparatus may include sufficient space for layout, built-in tools, guide rails, elevation means, lights, power outlets, safety features, tool and parts holders, and measuring devices to facilitate the work. In some embodiments, the apparatus comprises a height adjustable workbench that supports at least one vehicle component in a desired position while working on the vehicle component. The workbench includes means to facilitate loading/unloading the vehicle component. The workbench is also operable to guide and secure the vehicle component in an orientation efficacious for performing the desired work. Further, numerous safety features protect against common accidents that may occur during the course of maintenance, repair and servicing operations. The at least one vehicle component may include, without limitation, a tire, a rim, a wheel hub assembly, a brake system, an engine, a transmission, and a car frame. The present invention may also be operable to enable work on an eclectic assortment of objects, including, without limitation, a cabinet, an airplane component, a metal fastener, a plant, an electrical device, and an artisanal object. The work performed on the vehicle component may include, without limitation, patching a tire, lubricating the edges of a tire, removing a rim from a wheel, rotating a tire, checking tread on a tire, and performing general mechanical work. Further, the workbench may be operable to allow for the performance of various tasks from a desired height, and within proximity of the necessary tools. The work performed on the workbench may include, without limitation, grinding, welding, light casting, forging, sharpening, cleaning, lubricating, and assembly/disassembly. For example, without limitation, guiderails on opposing sides of the workbench secure six tires in a vertical orientation, whereby each tire can be systematically disassembled, and/or inspected for damage, and/or then repaired as needed while standing vertically. The elevation of the tires may be adjusted by manipulating one or more of a foot control, depressible buttons, switches, and/or other dual-action control systems. In other embodiments, the tires may be elevated using manual controls. Those skilled in the art, in light of the present teachings, will recognize that the workbench can be raised and lowered to a desired height for performing work, loading, and unloading the at least one vehicle component. The workbench is also configured to guide the at least one component to a desired position and orientation along the work surface of the beam. The workbench includes a tool storage portion for holding an eclectic variety of tools within easy reach, thereby reducing walking and reaching. Performing work on the vehicle components from a comfortable height, and with minimal movement, enhances and expedites the work performance.

In one embodiment of the present invention, an adjustable platform for enabling work on at least one vehicle component is disclosed, the apparatus comprising: a work surface, the work surface being configured to support a plurality of vehicle components, the work surface comprising a planar top surface having a plurality of concave depressions for securing the vehicle components; a frame affixed to the work surface, disposed underneath the work surface, the frame being configured to provide structural integrity to the adjustable platform, the frame comprising a plurality of beams and crossmembers welded together; one or more column portion(s), the one or more column portion(s) extending upwardly through the work surface, the one or more column portion(s) being configured to serve as guides when raising and lowering the work surface relative to the ground, the one or more column portion(s) comprising a jack, the jack being operable to apply a force necessary to raise the work surface, the one or more column portion(s) further comprising a work end, the work end disposed above the work surface, the work end comprising at least one support member shaped to engage the at least one vehicle component, the at least one support member further being configured to orient the at least one vehicle component, the at least one column portion further comprising a mount end, the mount end; at least one guiderail, the at least one guiderail being disposed to position along a peripheral edge of the work surface, the at least one guiderail being operable to guide the at least one vehicle component along a longitudinal axis of the work surface; and a cable support portion, the cable support portion being configured to carry a cable to and from the apparatus.

The adjustable platform may further comprise a plurality of support members 132 rising upward orthogonally from the work surface, the support members each comprising a T-shaped arm extendable to engage a recessed portion of a tire.

The at least one vehicle component may comprise at least one tire. The adjustable platform may further comprise a motor disposed beneath the work bench, the motor being operable to power one or more of the jack and the support members.

In other embodiments, the adjustable platform may be elevated with one or more of airbags, hydraulics, and manual controls.

The adjustable platform may further comprise a control switch, the control switch being operable to regulate one or more of the motor and the jack. In some embodiments, the adjustable platform further comprises a foot control device, the foot control device being operable to regulate one or more of the motor and the jack.

The adjustable platform may further comprise at least one power outlet, the at least one power outlet being disposed peripherally on the work surface. The jack may be operable to elevate the work surface above a ground surface.

The at least one column portion may be operable to telescopically raise the work surface. The adjustable platform may further comprise one more inclined ramps hingedly affixed to the work surface.

The ramp may comprise at least one guiderail for guiding the at least one vehicle component onto the work surface. The at least one depression and/or retaining spot may be shaped and dimensioned to at least partially receive a tire.

Other embodiments may include a planar surface having raised or detachable chalks or other upwardly rising components to maintain the position of a tire, the upwardly rising components defining a “retaining spot.”

In some embodiments, the at least one support member comprises at least one stationary support member and/or at least one adjustable support member. The tools storage portion may comprise a tool tray having a plurality of apertures, the plurality of apertures being disposed to position along a longitudinal axis of the work surface.

A method for enabling work on at least one vehicle component is disclosed, the method comprising: engaging a motor with a control switch; retracting a jack with a foot control to lower at least one column portion; loading at least one vehicle component on a work surface through a load portion; receiving at least part of at least one vehicle component, in at least one depression; positioning the at least one vehicle component to a desired orientation with at least one guiderail; accessing a tool from the tool storage portion; joining the tool with a power outlet; extending the jack with the foot control to raise the at least one column portion; working on the at least one vehicle component; retracting the jack with the foot control to lower the at least one column portion; and unloading the at least one vehicle component off the work surface through the load portion.

In other embodiments, the at least one vehicle components is received between upwardly rising members instead of by depressions in the planar surface.

The depressions are disposed between stationary support members and the guiderail.

The at least one vehicle component, at least partially, in at least one depression may further comprises the at least one depression guiding the at least one vehicle component along the work surface.

Another embodied adjustable platform is also disclosed, the apparatus comprising: means for powering on a motor with a control switch; means for retracting a jack with a foot control to lower at least one column portion; means for loading at least one vehicle component on a work surface through a load portion; means for receiving the at least one vehicle component, at least partially, in at least one depression or retaining spot; means for positioning the at least one vehicle component to a desired orientation with at least one guiderail; means for accessing a tool from the tool storage portion; means for joining the tool with a power outlet; means for extending the jack with the foot control to raise the at least one column portion; means for working on the at least one vehicle component; means for retracting the jack with the foot control to lower the at least one column portion; and means for unloading the at least one vehicle component off the work surface through the load portion.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIGS. 1A and 1B perspective views illustrating embodiments of the apparatus carrying exemplary vehicle components in a loading position, and a raised position, in accordance with the present invention;

FIG. 2 is a perspective view illustrating one embodiment of a beam joined with one embodiment of a load portion, in accordance with the present invention;

FIG. 3 is a perspective view illustrating one embodiment of at least one column portion joined with at least one support member, in accordance with the present invention;

FIG. 4 is a perspective view illustrating one embodiment of a mount surface with a frame, a jack, and a motor, in accordance with the present invention; and

FIG. 5 is a perspective view illustrating one embodiment of a beam with at least one tool storage portion, in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

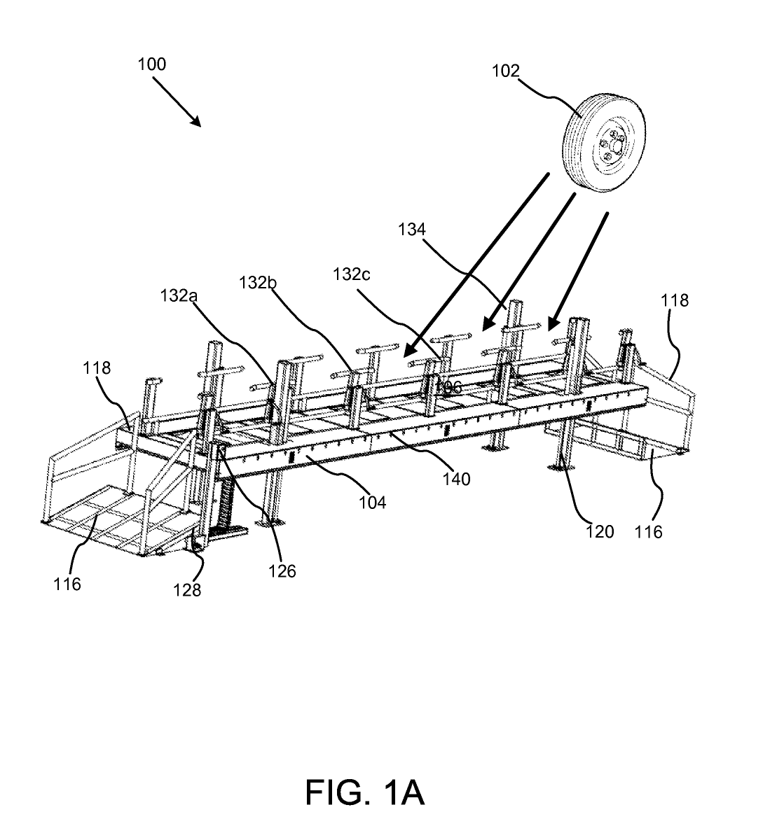

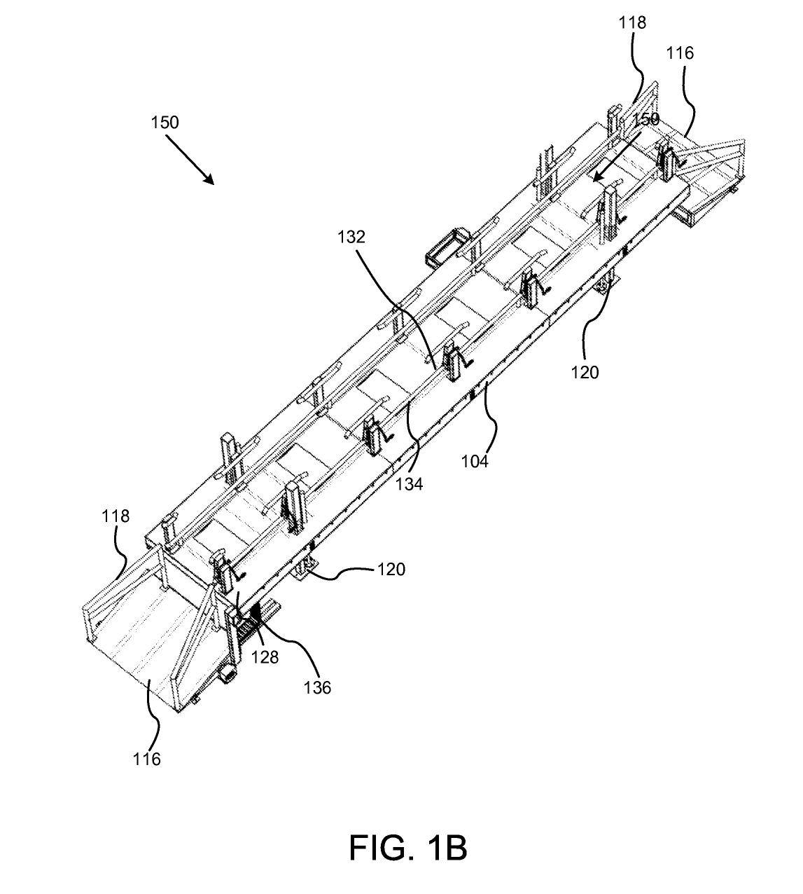

FIGS. 1A and 1B perspective views illustrating embodiments of the apparatus or workbench carrying exemplary vehicle components in a loading position, and a raised position, in accordance with the present invention. In the present invention, an apparatus for enabling work 100 comprises a workbench configured to enable work on at least one aircraft component 102. The at least one vehicle component may include, without limitation, a tire, a rim, a wheel hub assembly, a brake system, landing gear, hydraulics, and a fuselage. In some embodiments, the apparatus comprises a height adjustable workbench that holds the at least one aircraft component in a desired alignment, orientation, and direction while working on the aircraft component. The workbench includes means to facilitate loading/unloading of the aircraft component. The workbench is also operable to guide and secure the aircraft component in an orientation efficacious for performing the desired work. Further, numerous safety features protect against common accidents that may occur in proximity to the workbench.

The present invention may also be operable to enable work on an eclectic assortment of objects, including, without limitation, a plant, an electrical device, and an artisanal object or design. The work performed on the vehicle component may include, without limitation, changing a tire, patching a tire, lubricating the edges of a tire, removing a tire from a wheel, rotating a tire, inflating a tire, checking tread on a tire, and performing general mechanical work. Further, the workbench may be operable to allow for the performance of various tasks from a desired height, and within proximity of the necessary tools. The work performed on the workbench may include, without limitation, grinding, welding, light casting, forging, sharpening, cleaning, lubricating, and assembly/disassembly. For example, without limitation, guiderails on opposing sides of the workbench secure six tires in a vertical orientation, whereby each tire can be systematically inspected for damage, and then repaired as needed while standing. The elevation of the tires may be adjusted by manipulating a foot control. Those skilled in the art, in light of the present teachings, will recognize that the workbench can be raised and lowered to a desired height for performing work, loading, and unloading the at least one vehicle component. The workbench is also configured to guide the at least one component to a desired position and orientation along the work surface of the beam. The workbench includes a tool storage portion for holding an eclectic variety of tools within easy reach, thereby reducing walking and reaching. Performing work on the vehicle components from a comfortable height, and with minimal movement, enhances and expedites the work performance.

In one embodiment of the present invention, the apparatus includes a beam 104 for supporting a work surface 106. The beam 104 is affixed underneath a work surface 106, which work surface 106 is configured to engage at least one vehicle or aircraft component 102. In some embodiments, the work surface 106 is planar. In other embodiments, the work surface 106 may include steel diamond plating. The workbench 106 may define at least one concave recess or depression for locating and holding wheels or tires 102 in working position or a retaining spot between two upwardly rising protrusions. These recesses may be spaced across the length or breadth of the workbench a regular, repeating intervals.

In other embodiments, the work surface 106 may include a slip-resistant coating, including, without limitation, slip resistant diamond beam, rubber, thermally stable polyethylene terephthalate, protruding members, magnets, and adhesives. Those skilled in the art, in light of the present teachings, will recognize that working on vehicle or aircraft components often involves working with oils and small, round fasteners, thereby creating a slippery surface on the beam.

In some embodiments, the beam 104 and work surface 106 may extend 23 feet long. Crossmembers disposed perpendicularly to the beams 104 extend across the breadth of the work surface 104, which, in the shown embodiment is 4 feet 4 inches wide. These dimensions may allow sufficient surface area and tensile strength to support a large work load, for example, up to six wheels or tires at a time. However, the dimensions of the work surface 106 may vary from only two feet in width/breadth to twenty feet in width. The length may vary from only four feet to more than one hundred feet.

In one alternative embodiment, a person may stand on the beam while working on the vehicle component. In some embodiments, the work surface 106 further comprises a mount surface. The mount surface joins with a frame that is disposed to align along a longitudinal axis of the mount surface. The frame may include a tubular, steel or aluminum frame configured to provide structural integrity to the work surface, and the apparatus as a whole. However, the frame may be fabricated from other materials, including, without limitation, steel alloy, titanium, iron, fiberglass, high density plastic, and wood.

In one embodiment of the present invention, the mount surface positions on a lower side of the beam. The mount surface comprises a buffer portion that is configured to help restrict contact between the mount surface and an object. The buffer portion may include a rubber strip that positions along a peripheral edge of the mount surface. The buffer portion may be operable to detect proximity to an object and react by actuating a control switch to raise the beam. In this manner, an object beneath the mount surface, such as a foot, may avoid engagement with a lowering beam. For example, without limitation, the buffer portion may include a safety bumper that encircles around a bottom edge of the mount surface to help prevent pinching or crushing of toes or other objects when lowering the beam. The buffer portion may utilize infrared or lasers to detect the object, and then stop, and raise three inches.

In some embodiments, the apparatus 100 comprises a load portion 116 configured to help load the at least one vehicle or aircraft component on the work surface 106 and/or help unload the at least one vehicle component off the work surface 106, as well as to provide a ramp for operator access. The load portion 116 may include a ramp with at least one guardrail 118, whereby a tire 102 may roll onto the work surface 106. In some embodiments, the load portion 116 may detach from the beam 104 or work surface 106. However, in other embodiments, the load portion 116 may form an integral extension with the work surface 106. Typically the load portion 116 is hingedly affixed to the work surface 106, beam 104, or a crossmember.

In one embodiment of the present invention, at least one column portion 120 may extend orthogonally upward from and through the work surface 106. The at least one column portion 120 is operable to raise and support the work surface 106. The at least one column portion 120 may be disposed to orient outside the work surface 106 peripheral edge, or pass through the work surface 106. The at least one column portion 120 is configured to raise and/or lower the work surface 106. The at least one column portion 120 may telescopically extend and retract to provide the raising and lowering function, or may serve as a guide or track for the work surface 106 to be hydraulically raised and lowered. A jack joins with the at least one column portion 120 to apply a force for raising and/or lowering the at least one column portion 120. The jack may include a two ton screw jack, powered by a motor. The jack may additionally or alternatively comprise a hydraulic jack, a pneumatic jack, manually operated jack, and/or other jacks known to those of skill in the art. A motor powers the jack. A control switch 126 and a foot control 128 regulate the power for the motor, and the direction of the jack. The control switch may include, without limitation, a button, a switch, a dial, and a trigger. The foot control may include a covered pedal. In some embodiments, at least one tool storage portion positions along the beam to hold various tools. Each tool storage portion may be configured differently for variously shaped and dimensioned tools. For example, without limitation, the at least one tool storage portion may include a tool tray that contains fasteners and screwdrivers. The at least one tool storage portion may further include a plurality of apertures, such as keyhole slots for hanging tools and the tool tray.

In some embodiments, the workbench 100 comprises lights and/or electrical outlets.

In one embodiment of the present invention, the at least one column portion 120 comprises a work end that positions in proximity to the beam. The work end may include a top portion of the at least one column portion.

In some embodiments, the apparatus 100 comprises at least one support member 132, which is configured to engage the at least one vehicle or aircraft component, such as the shown tires 102. The at least one support member 132 can orient the at least one vehicle component to a desired position and direction. The support members 132, in the shown embodiment, are configured to hydraulically or electrically press against the tires 102 stowed on the work surface 106. The support members 132 are released and activated from a control panel affixed to the apparatus 100 such as the control switch 126. Alternatively the support members 132 may be released and extended manually with a lever, crank, or via other means known to those of skill in the art.

In this manner, the vehicle component 102 is stabilized and held securely for performing the appropriate work. The at least one support member 132 may be stationary and/or adjustable. A stationary support member 132 may provide a brace to direct the vehicle components along the work surface 106, and into an appropriate depression. An adjustable support member may position on an opposite side of the stationary support member, thereby providing a brace for variously sized vehicle components. In one alternative embodiment, adjustable wheel supports on an outboard side of the beam 104 or work surface 106 can be set to different wheel sizes. In some embodiments, the at least one column portion 120 further comprises a mount end towards a bottom portion of the column portion. The mount end is configured to engage a mount surface, such as the ground. The mount end may include a footing to provide additional stability to the apparatus.

The stationary support member 132 may be adjustable vertically using means known to those of skill in the art to accommodate tires of differing sizes. The stationary support members 132 may also be adjustable horizontally and/or laterally on a rail to accommodate tires or different sizes and dimensions. The adjustable support members may also be detachably affixable in place at different positions on the platform surface.

In one embodiment of the present invention, the at least one guiderail 134 positions along a peripheral edge of the work surface 106. For example, without limitation, one guardrail 134 may position two feet above the work surface 106 along a longitudinal axis of the work surface 106, attaching to each column portion 120 for support. The at least one guiderail 134 is operable to guide the at last one vehicle component 102 along a longitudinal axis of the work surface 106. The one depression and the at least one guardrail 134 serves to secure the vehicle components in a desired position and orientation for enabling work. The at least one guard rail 134 may also position onto the load portion. In one embodiment, a cable support portion 136 serves to carry a cable and/or wire, and/or tube to and from the apparatus. The cable support portion may include a flexible tray that positions along the beam, in proximity to the power outlets.

The apparatus 100 comprises, or defines, keyhole slots 140 for securing various detachably affixed accessories, including baskets, tool boxes, cabinets, and the like to the side of the apparatus 100.

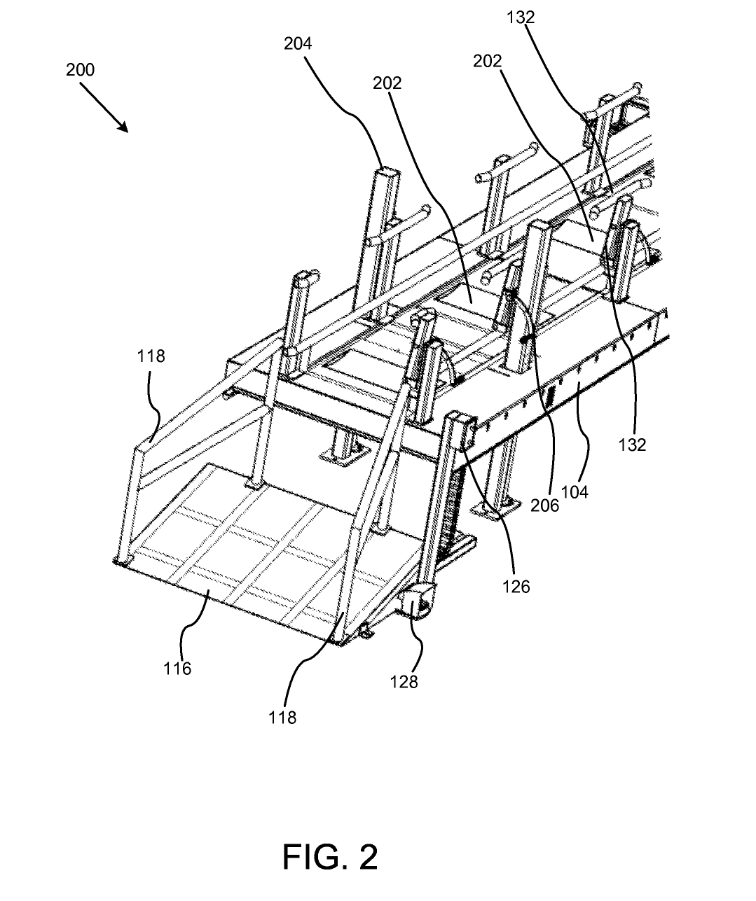

FIG. 2 is a perspective view illustrating one embodiment of a work surface 106 joined with one embodiment of a load portion 116, in accordance with the present invention. In the present invention, the apparatus 200 includes a work surface 106 for supporting the at least one vehicle component 102. Suitable materials for fabricating the work surface 106 may include, without limitation, steel, aluminum, iron, metal alloys, high density polymers, and wood. The work surface 106 comprises a largely planar surface configured to engage at least one vehicle component. In some embodiments, the work surface 102 may include steel diamond plating with at least one depression 202 for guiding and holding vehicle components, such as wheels or tires 102, in working position. The at least one depression 202 is configured to at least partially receive the at least one vehicle component. The at least one depression 202 forms a centrally located slot on the work surface 106. The slot may be sized and dimensioned to receive a tire 102. However, in other embodiments, the depression 102 may be otherwise shaped to appear, without limitation, as a circle, a rectangle, a square, and a plurality of dimples.

In one embodiment of the present invention, at least one column portion 120 functions to raise and lower the work surface 106. The column portion 120 utilizes a telescopic movement, or pneumatic movement, or hydraulics, to raise and lower the apparatus 100. In some embodiments, the top portion of the at least one column portion 120 includes a work end 204 that positions in proximity to the work surface 106. The work end may include a top portion of the at least one column portion 120. The work end provides an area on each column portion to join with the support member and substantially engage the vehicle component.

The support members 132 in the shown embodiment is extended and retracts with a handcrank 206 pivotably affixed to the support member 132.

The support members 132 comprise T-shaped braces hingedly affixed to the upwardly rising columns which extend, or press forward, onto the sidewall portion of the tires 102.

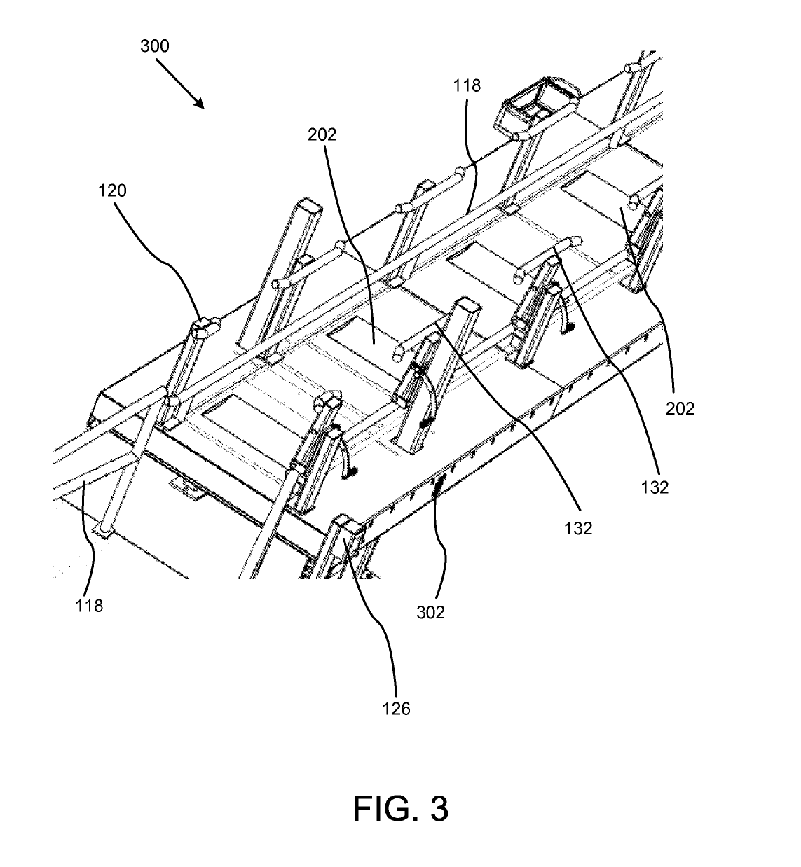

FIG. 3 is a perspective view illustrating one embodiment showing at least one column portion 120 joined with at least one support member 132, in accordance with the present invention. In the present invention, either the at least one column portion 120, or the at least one support member 132 may include at least one power outlet 302. Power outlets 302 may be spaced across the apparatus 300.

In yet another embodiment, the beam may include one or more power outlets 304 on each side of the work surface 106. For example, without limitation, the at least one power outlet 302 may include a plurality of one hundred-twenty volt alternating current plugs on each side of the beam, or electrical voltages and current forms including direct current. A plurality of power outlets 302 allows for facilitated access and movement while working Extension cords may be stored with the apparatus, and join with the at least one power outlet as well as other electrical systems.

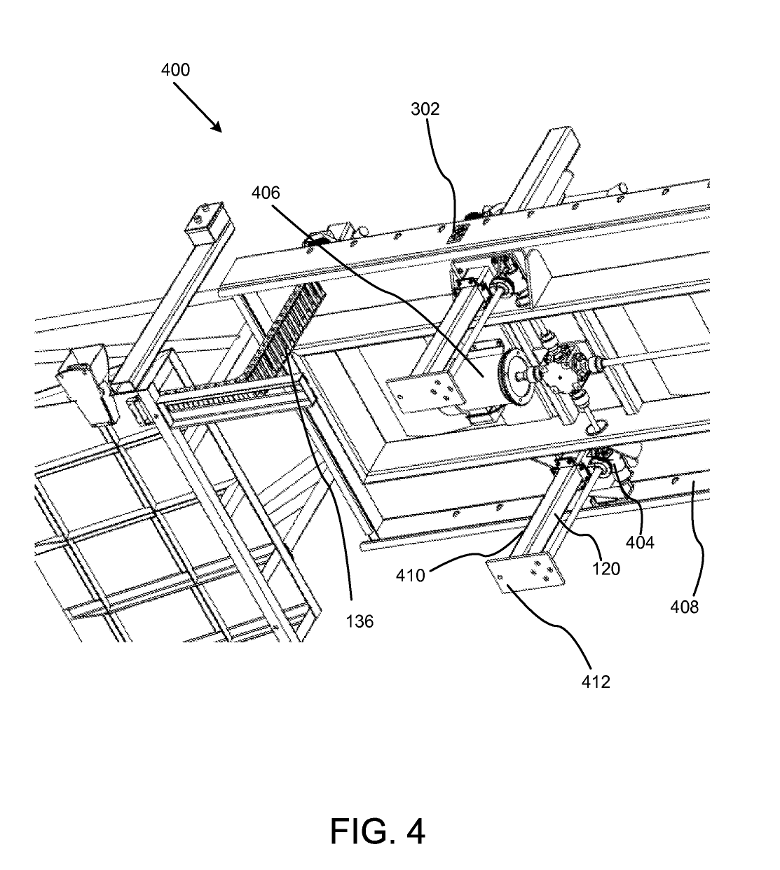

FIG. 4 is a lower perspective view illustrating one embodiment of a workbench 400 in accordance with the present invention.

In the present invention, the work surface 106 overlays a frame 402. The frame 402 may comprise a tubular, C-shaped, I-shaped, or components designed and configured to provide structural integrity to the work surface 106 the apparatus 400 as a whole. The frame 402 may comprise any combination or series of beams, crossmembers, gusset plates, bars, bolts, stiffeners, trusses, braces and the like.

Fasteners, such as high strength bolts, may secure the frame 402 to the work surface 106. The work surface 106 may also be welded to the frame 402. The frame 402 may be fabricated from other materials, including, without limitation, steel alloy, titanium, iron, fiberglass, high density plastic, and wood. A jack 404 may provide sufficient force to raise and lower the work surface 106 along the column support 120. The jack 404 may include a screw jack, shown in this embodiment as a two ton screw jack. The screw jacks are self-locking and will prevent the work surface 106 from falling or lowering unless under power from the motor. However, in other embodiments, pneumatic, electromechanical, and/or hydraulic jacks may be utilized, as well as other lifting mechanisms known to those of skill in the art.

In one embodiment, a motor 406 may power the jack and/or structural supports 132. The motor 406 may include a five horse power, two hundred-twenty volt, three-phase motor; or other sizes of motors. Other sizes of motors may be utilized. However, in other embodiments, a hand crank may power the jack. A mount end 410 of the at least one column portion 120 is configured to engage a mount surface, such as the ground. The mount end 410 may include a footing 412 to provide additional stability to the apparatus 400. The footing 412 may secure to the mount surface with an anchor bolt.

In one embodiment of the present invention, the lateral edges of the work surface 106 fold downward hiding the beam 104 and frame 402. These lateral edges may comprise a buffer portion 408 that is configured to help restrict contact between the lateral edges and an object and/or the ground. The buffer portion 408 may include a rubber strip that positions along a peripheral edge of the work surface 106. The buffer portion 408 may utilize a laser or infrared to detect the distance to the ground.

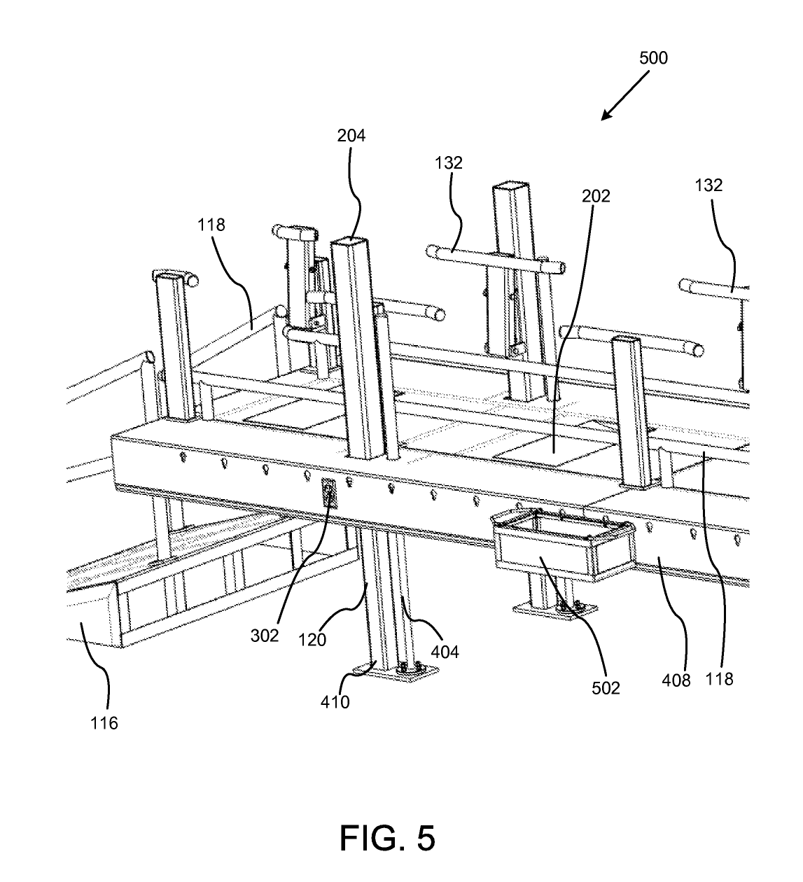

FIG. 5 is an elevational perspective view illustrating one embodiment of a work platform 500 with at least one tool storage portion, in accordance with the present invention.

In the present invention, at least one tool storage portion 502 positions along the beam to hold various tools. Each tool storage portion 502 may be shaped differently to accommodate variously shaped and dimensioned tools. For example, without limitation, the at least one tool storage portion 502 may include a tool tray that contains fasteners and screwdrivers. The at least one tool storage portion may further include a plurality of apertures, such as keyhole slots for hanging tools and the tool tray. The plurality of apertures may position equidistant along a peripheral edge of the beam. In one alternative embodiment, the tools may attach to the beam with various means, including, without limitation, magnets, adhesives, slots, and hook and loop fasteners.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An adjustable platform for enabling safe and efficient work on at least one vehicle component, the apparatus comprising:
a work surface, the work surface being configured to support a plurality of vehicle components, the work surface comprising a planar top surface having one or more of: a retaining spot and a concave depressions for securing the vehicle components;
a frame affixed to the work surface, disposed underneath the work surface, the frame being configured to provide structural integrity to the adjustable platform, the frame comprising a plurality of beams and crossmembers fastened together;
one or more column portion(s), the one or more column portion(s) extending upwardly through the work surface, the one or more column portion(s) being configured to serve as guides when raising and lowering the work surface relative to the ground, the one or more column portion(s) comprising a jack, the jack being operable to apply a force necessary to raise the work surface, the one or more column portion(s) further comprising a work end, the work end disposed above the work surface, the work end comprising at least one support member shaped to engage the at least one vehicle component, the at least one support member further being configured to orient the at least one vehicle component, the at least one column portion further comprising a mount end, the mount end;
at least one guiderail, the at least one guiderail being disposed to position along a peripheral edge of the work surface, the at least one guiderail being operable to guide the at last one vehicle component along a longitudinal axis of the work surface;
one or more inclined ramps, disposed adjacent to the longitudinal ends of the work surface in its lowered position, for accessing the work surface; and
a cable support portion, the cable support portion being configured to carry a cable to and from the apparatus.

2. The adjustable platform of claim 1, wherein each retaining spot comprises one of: a concave depressions for securing a vehicle component and a recess between to raised protrusions for securing a vehicle component.

3. The adjustable platform of claim 1, further comprising one or more support members 132 rising upward orthogonally from the work surface, the support members each comprising a T-shaped arm extendable to engage a portion of a tire.

4. The adjustable platform of claim 1, wherein the at least one vehicle component comprises one of a wheel and tire.

5. The adjustable platform of claim 1, further comprising a motor disposed beneath the work bench, the motor being operable to power one or more of the jack and the support members.

6. The adjustable platform of claim 1, further comprising a dual-control switch, the control switch being operable to regulate one or more of the motor and the jack.

7. The adjustable platform of claim 1, further comprising a control device, the control device being operable to regulate one or more of the motor and the jack.

8. The adjustable platform of claim 1, wherein the control device comprises one of a foot control device and a momentary contact switch.

9. The adjustable platform of claim 1, further comprising at least one power outlet, the at least one power outlet being disposed peripherally on the work surface.

10. The adjustable platform of claim 1, further comprising one or lights for illuminating the work surface.

11. The adjustable platform of claim 1, wherein the at least one column portion is operable to telescopically raise the work surface.

12. The adjustable platform of claim 1, further comprising one or more inclined ramps hingedly affixed to the work surface.

13. The adjustable platform of claim 10, wherein the ramp comprises the at least one guiderail for guiding the at least one vehicle component onto the work surface.

14. The adjustable platform of claim 1, wherein the at least one depression is shaped and dimensioned to at least partially receive a tire.

15. The adjustable platform of claim 1, further comprising one or more upwardly rising protrusions defining a retaining spot between them for maintaining a tire in one position.

16. The adjustable platform of claim 1, wherein the at least one support member comprises at least one stationary support member and/or at least one adjustable support member.

17. The adjustable platform of claim 1, wherein the tools storage portion comprises one or more of a box, a cabinet, a tray, a bin, and a basket.

18. A method for enabling work on at least one vehicle component, the method comprising:
retracting a jack with a control to lower at least one column portion;
loading at least one of a wheel and tire on a work surface through an inclined ramp;
receiving the at least one vehicle component, at least partially, in at least one of a concave depression and retaining spot;
positioning the at least one vehicle component to a desired orientation with at least one guiderail;
extending the jack with the control to raise the at least one column portion;
working on the at least one vehicle component;
retracting the jack with the control to lower the at least one column portion; and
unloading the at least one vehicle component off the work surface through the inclined ramp.

19. The method of claim 17, wherein the at least one vehicle component is partially receiving in one of: a concave depression in the work surface and a retaining spot above the work surface between two upwardly rising protrusions.

20. An adjustable platform, the apparatus comprising:
means for powering on a motor with a control switch, the control switch operable by one or more of a hand crank, an air wrench, hydraulics, pneumatics, and a depressible button;
means for retracting a jack with a foot control to lower at least one column portion;
means for loading at least one vehicle component on a work surface through a load portion;
means for receiving the at least one vehicle component, at least partially, in at least one depression;
means for positioning the at least one vehicle component to a desired orientation with at least one guiderail;
means for accessing a tool from the tool storage portion;
means for joining the tool with a power outlet;
means for extending the jack with the foot control to raise the at least one column portion;
means for working on the at least one vehicle component;
means for retracting the jack with the foot control to lower the at least one column portion; and
means for unloading the at least one vehicle component off the work surface through the load portion.
